(19) United States
(12) Patent Application Publication
(10) Pub. No.: US 2026/0113559 A1
(43) Pub. Date: Apr. 23, 2026

(54) EARPHONE

(71) Applicant: SHENZHEN SHOKZ CO., LTD., Shenzhen (CN)

(72) Inventors: Tao ZHAO, Shenzhen (CN); Jiaming ZHANG, Shenzhen (CN); Jiang XU, Shenzhen (CN); Lei ZHONG, Shenzhen (CN)

(73) Assignee: SHENZHEN SHOKZ CO., LTD., Shenzhen (CN)

(21) Appl. No.: 19/424,085

(22) Filed: Dec. 17, 2025

Related U.S. Application Data
(63) Continuation of application No. PCT/CN2024/096714, filed on May 31, 2024.

(51) Int. Cl. H04R 1/10

(52) U.S. Cl. CPC H04R 1/1016; H04R 1/1058

(57) ABSTRACT

Provided is an earphone. The earphone includes a first housing assembly configured to form an accommodation cavity, a battery, and a circuit board assembly, the battery and the circuit board assembly being disposed in the accommodation cavity. The circuit board assembly includes a first rigid circuit board, a second rigid circuit board, and a first flexible circuit board, the first rigid circuit board and the second rigid circuit board are arranged at intervals at two ends of the battery along an axial direction of the battery, a projection of the first rigid circuit board and a projection of the second rigid circuit board along the axial direction of the battery at least partially overlap with an end surface of the battery, and a projection of the first flexible circuit board along a radial direction of the battery at least partially overlaps with a circumferential surface of the battery.

### CROSS-REFERENCE TO RELATED APPLICATIONS

This application is a Continuation of International Application No. PCT/CN2024/096714, filed on May 31, 2024, the contents of which are incorporated herein by reference.

### TECHNICAL FIELD

The present disclosure relates to the technical field of electronic devices, and particularly relates to an earphone.

### BACKGROUND

With the continuous popularization of electronic devices, electronic devices have become indispensable social and entertainment tools in the daily lives of people, and requirements for electronic devices are also increasing. Earphones, as electronic devices, have also been widely applied in the daily lives of people, and may be used in cooperation with terminal devices such as mobile phones and computers to provide an auditory experience for users. According to working principles, earphones may generally be divided into air-conduction earphones and bone-conduction earphones; according to wearing manners of users, the earphones may generally be divided into head-mounted earphones, ear-clip earphones, and in-ear earphones; and according to interaction manners between the earphones and electronic devices, the earphones may also be divided into wired earphones and wireless earphones. With the increase in user demands, existing ear-clip earphones are required to be equipped with a large quantity of circuit elements and antenna assemblies, and meanwhile need to be provided with a larger-volume battery to meet power supply requirements. Therefore, how to reduce spatial limitations of the battery on the antenna assemblies and how to reduce signal interference have become technical problems urgently to be solved.

### SUMMARY

An earphone is provided in embodiments of the present disclosure. The earphone comprises a first housing assembly configured to form an accommodation cavity, a battery, and a circuit board assembly, the battery and the circuit board assembly being disposed in the accommodation cavity, wherein the battery is arranged in a columnar shape, the circuit board assembly includes a first rigid circuit board, a second rigid circuit board, and a first flexible circuit board, the first rigid circuit board and the second rigid circuit board are arranged at intervals at two ends of the battery along an axial direction of the battery, the first flexible circuit board connects the first rigid circuit board and the second rigid circuit board, a projection of the first rigid circuit board and a projection of the second rigid circuit board along the axial direction of the battery at least partially overlaps with an end surface of the battery, and a projection of the first flexible circuit board along a radial direction of the battery at least partially overlaps with a circumferential surface of the battery.

In some embodiments, a ratio of an area of the first rigid circuit board to a total projection area of the first rigid circuit board along the axial direction of the battery is greater than or equal to 80%, and a ratio of an area of the second rigid circuit board to a total projection area of the second rigid circuit board along the axial direction of the battery is greater than or equal to 80%.

In some embodiments, a main surface of the first rigid circuit board is arranged facing toward or away from an adjacent end surface of the battery and a main surface of the second rigid circuit board is arranged facing toward or away from another adjacent end surface of the battery; and an angle between a normal direction of the main surface of the first rigid circuit board and the axial direction of the battery and an angle between a normal direction of the main surface of the second rigid circuit board and the axial direction of the battery are less than or equal to 10°, respectively.

In some embodiments, the earphone further comprises a microphone and a wearing detection electrode disposed in the accommodation cavity, the first flexible circuit board includes a main circuit board extending along the axial direction of the battery and connecting the first rigid circuit board and the second rigid circuit board, the first flexible circuit board further includes a first branch circuit board and a second branch circuit board, and one end of the first branch circuit board and one end of the second branch circuit board are located on two opposite sides of the main circuit board along a circumferential direction of the battery, respectively, the other end of the first branch circuit board is connected to the wearing detection electrode, and the other end of the second branch circuit board is connected to the microphone.

In some embodiments, the first housing assembly is provided with a connection through hole, the circuit board assembly further includes an electrode terminal configured to supply power to the battery, a main surface of the main circuit board is arranged opposite to the connection through hole, and the electrode terminal is connected to the main circuit board and is exposed through the connection through hole.

In some embodiments, an inner side of the first housing assembly is provided with a first platform configured as a planar surface, and the connection through hole is disposed in the first platform, the earphone further comprises a rigid bracket disposed in the accommodation cavity, a side of the rigid bracket facing the first platform is provided with a second platform configured as a planar surface, the electrode terminal is disposed in the second platform, and the first platform and the second platform are attached to each other, and at least a portion of the main circuit board is clamped between the first platform and the second platform.

In some embodiments, the earphone further comprises a first antenna part and a second antenna part, the first antenna part is arranged at intervals along the axial direction of the battery on a side of the first rigid circuit board away from the battery, the second antenna part is arranged at intervals along the axial direction of the battery on a side of the second rigid circuit board away from the battery, the circuit board assembly further includes a second flexible circuit board connected to the first rigid circuit board and a third flexible circuit board connected to the second rigid circuit board, and the second flexible circuit board is further connected to the first antenna part, and the third flexible circuit board is further connected to the second antenna part.

In some implementations, the first antenna part and the second antenna part further act as touch electrodes configured to receive touch signals.

In some embodiments, in a wearing state, the axial direction of the battery intersects a horizontal plane of a human body.

In some embodiments, the earphone further comprises a second housing assembly, an ear hook part, and a sound generation component, the sound generation component is disposed in the second housing assembly, and the ear hook part connects the first housing assembly and the second housing assembly, in the wearing state, the first housing assembly and the second housing assembly form a clamping state on two sides of a helix, the second housing assembly is located in a cavum conchae, the ear hook part has a symmetry plane arranged along a length direction of the ear hook part, and the axial direction of the battery intersects the symmetry plane.

The advantageous effects of the present disclosure are as follows. The circuit board assembly in the earphone of the present disclosure includes the first rigid circuit board, the second rigid circuit board, and the first flexible circuit board. Along the axial direction of the battery, the first rigid circuit board and the second rigid circuit board are arranged at intervals at the two ends of the battery. For example, the first rigid circuit board may be disposed in a first circuit board accommodation region, and the second rigid circuit board may be disposed in a second circuit board accommodation region. Such an arrangement can effectively ensure board surface areas of the first rigid circuit board and the second rigid circuit board (i.e., areas of main surfaces used for disposing circuit elements), so that circuit element space utilization of the battery and the circuit board assembly can also be effectively improved while the circuit board assembly is capable of integrating more circuit elements. Furthermore, projections of the first rigid circuit board and the second rigid circuit board along the axial direction of the battery at least partially overlap with end surfaces of the battery, and a projection of the first flexible circuit board along a radial direction of the battery at least partially overlaps with a circumferential surface of the battery. Accordingly, space utilization of the battery and the circuit board assembly can be further improved.

It should be understood that the above general description and the following detailed description are merely exemplary and explanatory, and are not intended to limit the present disclosure.

### BRIEF DESCRIPTION OF THE DRAWINGS

In order to more clearly illustrate technical solutions of embodiments of the present disclosure, drawings required for describing the embodiments will be briefly introduced below. Obviously, the drawings described below are merely some embodiments of the present disclosure, and for those skilled in the art, other drawings may also be obtained based on the drawings without creative efforts.

FIG. 1 is a front schematic diagram illustrating an earphone worn on an ear of people with large ears or small ears according to some embodiments of the present disclosure;

FIG. 2 is a three-dimensional schematic diagram illustrating the earphone shown in FIG. 1 according to some embodiments of the present disclosure;

FIG. 3 is a schematic diagram illustrating a structure of the earphone shown in FIG. 2 from direction A according to some embodiments of the present disclosure;

FIG. 4 is a three-dimensional schematic diagram illustrating an ear hook part and an abutting part of the earphone shown in FIG. 2 according to some embodiments of the present disclosure;

FIG. 5 is an exploded schematic diagram illustrating the ear hook part and the abutting part shown in FIG. 4 according to some embodiments of the present disclosure;

FIG. 6 is a three-dimensional schematic diagram illustrating an embedded body shown in FIG. 5 according to some embodiments of the present disclosure;

FIG. 7 is an exploded schematic diagram illustrating the embedded body shown in FIG. 6 according to some embodiments of the present disclosure;

FIG. 8 is a three-dimensional schematic diagram illustrating a rigid bracket of the embedded body shown in FIG. 7 according to some embodiments of the present disclosure; and

FIG. 9 is a three-dimensional schematic diagram illustrating a second housing of the earphone shown in FIG. 5 according to some embodiments of the present disclosure.

### DETAILED DESCRIPTION

The present disclosure will be further described in detail below in conjunction with the drawings and embodiments. It should be particularly noted that the following embodiments are merely used for illustrating the present disclosure and are not intended to limit the scope of the present disclosure. Similarly, the following embodiments are only a portion of the embodiments of the present disclosure rather than all embodiments, and all other embodiments obtained by those skilled in the art without creative efforts fall within the scope of protection of the present disclosure.

In the present disclosure, reference to “embodiment” means that specific features, structures, or characteristics described in connection with the embodiment may be included in at least one embodiment of the present disclosure. It should be explicitly and implicitly understood by those skilled in the art that the embodiments described in the present disclosure may be combined with other embodiments.

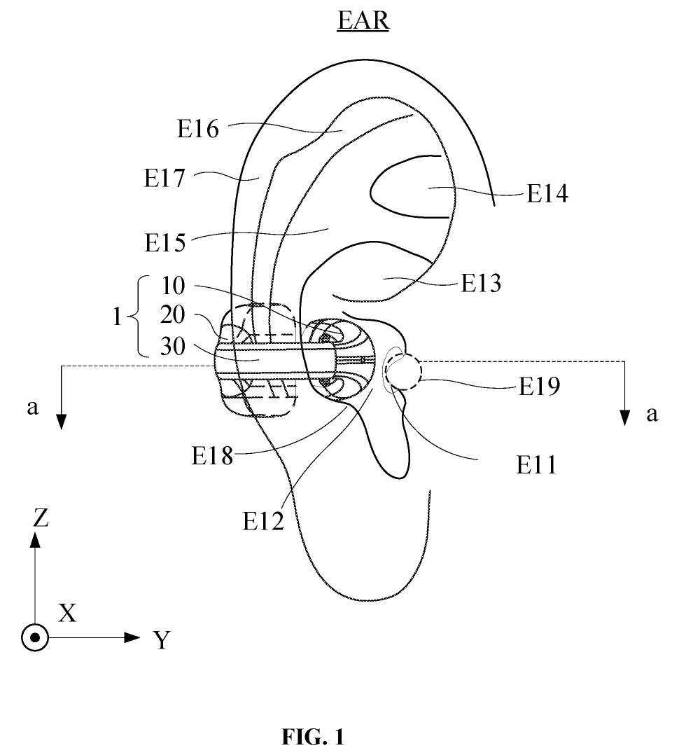

Referring to FIG. 1, an ear (EAR) of a user may include physiological parts such as an external auditory canal E11, a cavum conchae E12, a cymba conchae E13, a triangular fossa E14, an antihelix E15, a scaphoid fossa E16, a helix E17, and an antitragus E18. Although the external auditory canal E11 has a certain depth and extends to a tympanic membrane of the ear, for ease of description and in conjunction with FIG. 1, unless otherwise specified in the present disclosure, the external auditory canal E11 specifically refers to an entrance thereof away from the tympanic membrane, i.e., an ear orifice. Furthermore, physiological parts such as the cavum conchae E12, the cymba conchae E13, and the triangular fossa E14 have certain volumes and depths; and the cavum conchae E12 is directly communicated with the external auditory canal E11, that is, the aforementioned ear orifice may simply be regarded as being located at a bottom of the cavum conchae E12.

Furthermore, there is a tragus E19 at the outer periphery of the external auditory canal of the ear (EAR). Compared with the cavum conchae E12, the cymba conchae E13, and the triangular fossa E14, which have certain depths and volumes in a three-dimensional space, namely, which are recessed toward a rear side of the ear in a direction close to a head of the user, the tragus E19 protrudes toward a front side of the ear in a direction away from the head of the user. “A front side of the ear” is a concept relative to “a rear side of the ear,” where the former refers to a side of the ear away from the head (as shown in FIG. 1), and the latter refers to a side of the ear toward the head, both referring to the ear of the user.

Furthermore, different users may have individual differences, resulting in dimensional differences such as different shapes and sizes of ears. For ease of description and for reducing (or even eliminating) the individual differences of different users, for ease of description and understanding, unless otherwise specified, the present disclosure mainly takes an ear model with “standard” shapes and sizes as a reference to further describe wearing manners of acoustic devices in different embodiments on the ear model. For example, a simulator including a head and ears (left and right) may be manufactured based on ANSI: S3.36, S3.25, and IEC: 60318-7 standards, such as GRAS 45BC KEMAR, and used as a reference for wearing the acoustic device, so as to present scenarios in which most users normally wear the acoustic device. Merely by way of example, the ear used as a reference may have the following related features: a size of a projection of an auricle in a sagittal plane in a vertical axis direction may be in a range of 49.5 mm to 74.3 mm, and a size of a projection of the auricle in the sagittal plane in a sagittal axis direction may be in a range of 36.6 mm to 55 mm. Therefore, in the present disclosure, descriptions such as “a wearer wears,” “in a wearing state,” and “under a wearing state” may refer to the acoustic device of the present disclosure being worn on the ear of the simulator described above. Of course, in consideration of individual differences among different users, one or more parts of the ear (EAR) may have certain differences in structure, shape, size, or thickness. In order to meet requirements of different users, the acoustic device may be subjected to differentiated designs, which may be embodied in that one or more structures of the acoustic device (for example, a sound generation part 10, an ear hook part 30 described below) may have characteristic parameters with different ranges of values so as to adapt to different ears.

It should be noted that in fields such as medicine and anatomy, three basic planes of a human body may be defined, including a sagittal plane, a coronal plane, and a horizontal plane, and three basic axes may be defined, including a sagittal axis, a coronal axis, and a vertical axis. The sagittal plane refers to a plane perpendicular to the ground made along a front-back direction of the body, which divides the human body into left and right parts; the coronal plane refers to a plane perpendicular to the ground made along a left-right direction of the body, which divides the human body into front and back parts; and the horizontal plane refers to a plane parallel to the ground made along an up-down direction of the body, which divides the human body into upper and lower parts. Correspondingly, the sagittal axis refers to an axis along the front-back direction of the body and perpendicular to the coronal plane, the coronal axis refers to an axis along the left-right direction of the body and perpendicular to the sagittal plane, and the vertical axis refers to an axis along the up-down direction of the body and perpendicular to the horizontal plane. Furthermore, the “front side of the ear” described in the present disclosure is a concept relative to the “rear side of the ear,” where the former refers to a side of the ear away from the head, and the latter refers to a side of the ear toward the head, both referring to the ear of the user. By observing the ear of the simulator described above along a direction of the coronal axis of the human body, a schematic diagram of a contour of the front side of the ear, as shown in FIG. 1, may be obtained. In this way, in conjunction with FIG. 1, X, Y, and Z directions may be simply regarded as the coronal axis of the human body, the sagittal axis of the human body, and the vertical axis of the human body, respectively; and XY, XZ, and YZ planes may be simply regarded as the horizontal plane of the human body, the coronal plane of the human body, and the sagittal plane of the human body, respectively.

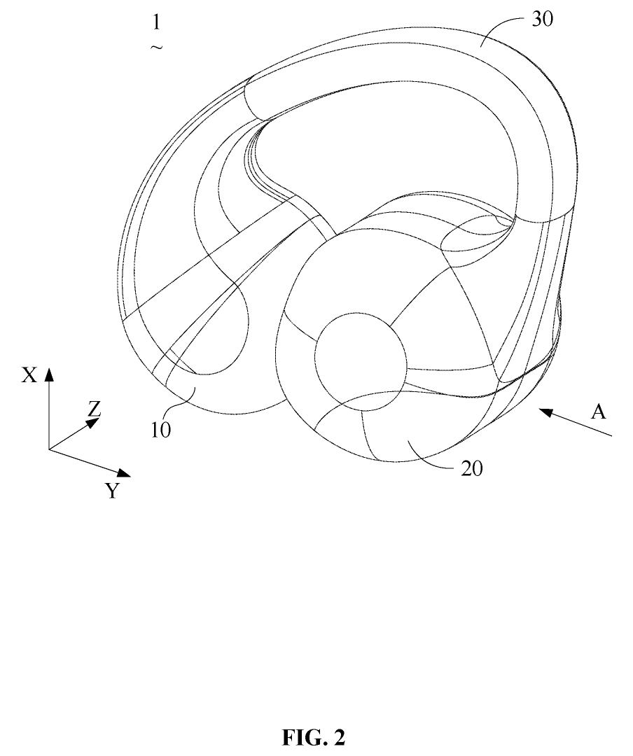

Referring to FIGS. 2-4, the present disclosure provides an earphone 1, which is an ear-clip earphone 1. The earphone 1 includes a sound generation part 10 inserted into a cavum conchae E12 of a wearer, an abutting part 20 configured to abut against a back of the ear of the wearer, and an ear hook part 30 connected to the sound generation part 10 and the abutting part 20. The sound generation part 10 is a sound playback device configured to convert electric signals into sound signals and play the sound signals to the wearer, and is located in the cavum conchae E12 in a wearing state. The abutting part 20 and the sound generation part 10 form a clamping state to abut against an outer side wall of the cavum conchae E12 and an inner side wall of the cavum conchae E12, respectively, so as to clamp the entire earphone 1 on an ear of a user. In some embodiments, the abutting part 20 may serve as a battery compartment for mounting a battery 222 or other components. Of course, the abutting part 20 may also not serve as the battery compartment, and the battery 222 may be mounted in the sound generation part 10. The ear hook part 30 is a component configured to provide a clamping force, two ends of the ear hook part 30 are connected to the sound generation part 10 and the abutting part 20, respectively, and in the wearing state, the ear hook part 30 bypasses the helix E17 so that the sound generation part 10 and the abutting part 20 are located on two sides of the ear of the human body along a coronal axis of the human body, and the sound generation part 10 extends into the cavum conchae E12 to transmit sound to the external auditory canal.

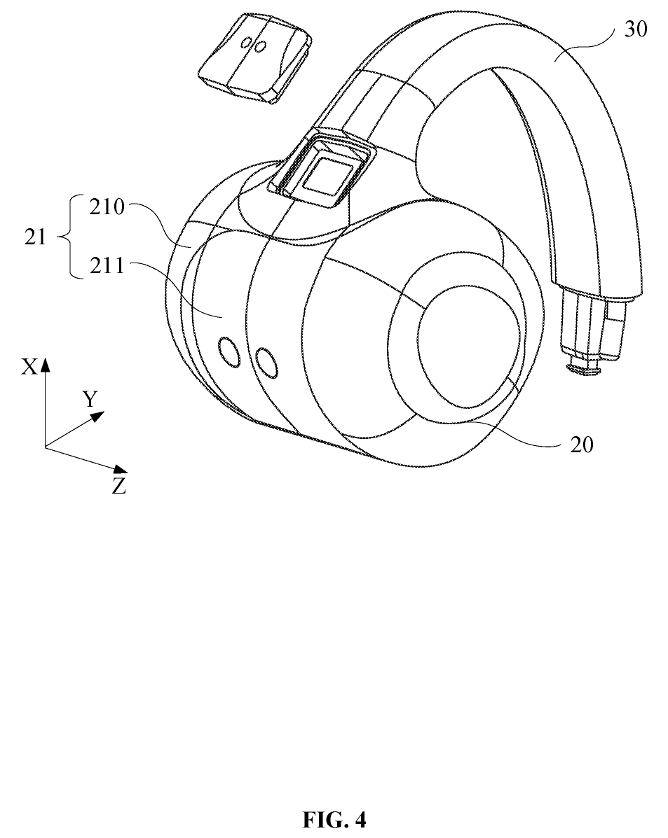

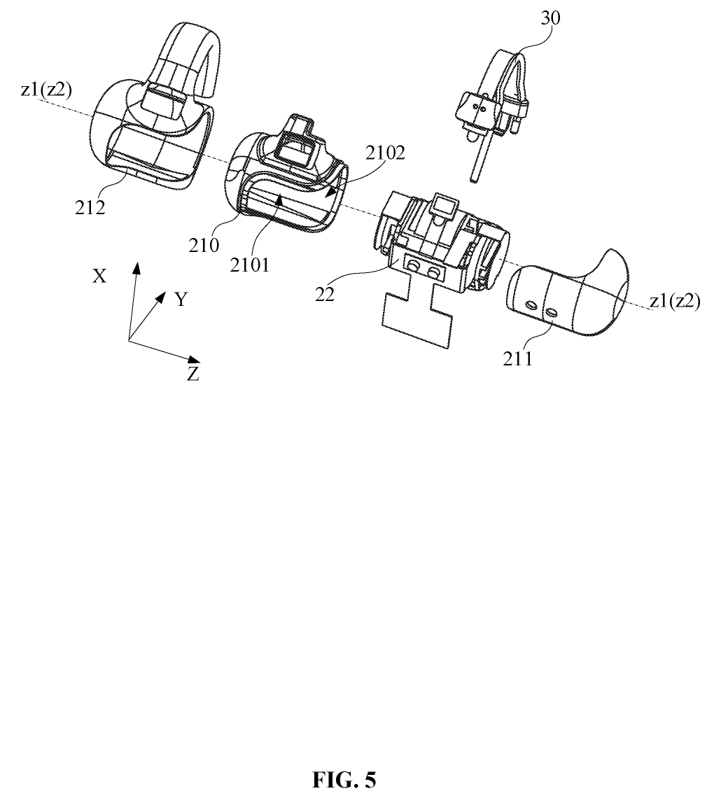

Optionally, as shown in FIGS. 4-5, in some embodiments, the abutting part 20 includes a first housing assembly 21. The first housing assembly 21 includes a first housing 210. The first housing 210 forms an accommodation cavity 2101 having a first opening 2102. The earphone 1 includes an embedded body 22 embedded into the accommodation cavity 2101 via the first opening 2102. The embedded body 22 may be an assembly of corresponding components of the earphone 1 required to be mounted in the accommodation cavity 2101. In this way, components required to be disposed in the accommodation cavity 2101 are integrated and assembled into the embedded body 22, and then embedded into the accommodation cavity 2101 via the first opening 2102, thereby effectively improving assembly efficiency and assembly convenience of the earphone 1. In some embodiments, the first housing assembly 21 further includes a second housing 211. The second housing 211 may cooperate with the first housing 210 to cover the first opening 2102, thereby sealing the accommodation cavity 2101. In this way, the first housing assembly 21 forms a sealed accommodation cavity 2101 through cooperation between the first housing 210 and the second housing 211. On one hand, a sealed environment may be effectively provided for the embedded body 22 disposed in the accommodation cavity 2101, thereby effectively improving working stability and service life of the embedded body 22; on the other hand, assembly convenience and assembly efficiency of the earphone 1 can also be effectively improved.

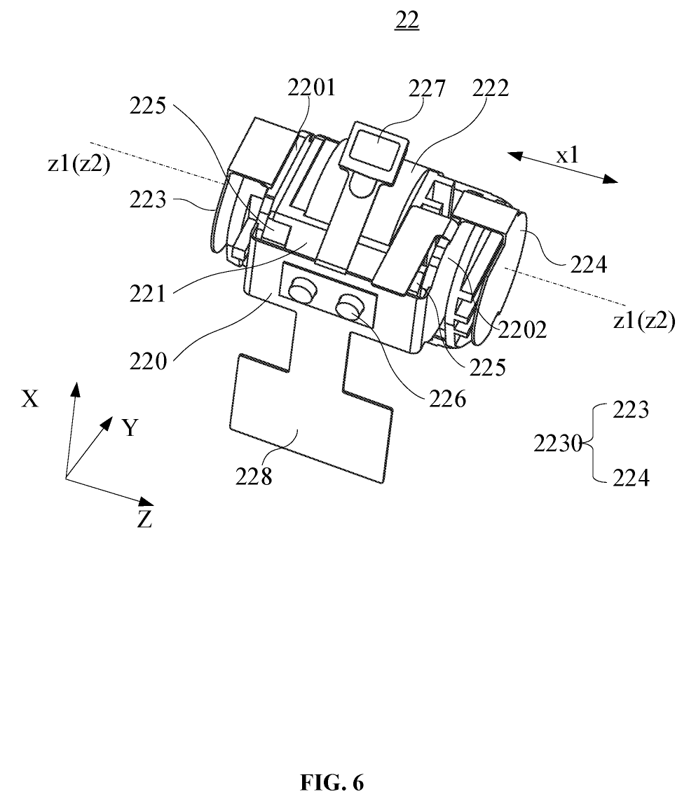

Optionally, as shown in FIG. 6, in some embodiments, the embedded body 22 includes a battery 222, a circuit board assembly 220, and a rigid bracket 221. In some embodiments, components required to be mounted in the accommodation cavity 2101 at least include the battery 222 and the circuit board assembly 220, where the battery 222 and the circuit board assembly 220 are disposed on the rigid bracket 221 and remain relatively fixed with the rigid bracket 221, so as to form the embedded body 22. The embedded body 22 is then embedded into the accommodation cavity 2101 via the first opening 2102 to realize assembly. In this way, assembly efficiency and assembly convenience of mounting the battery 222 and the circuit board assembly 220 and other components into the accommodation cavity 2101 can be effectively improved. Furthermore, the rigid bracket 221 may provide rigid support for the circuit board assembly 220 and the battery 222. During an assembly process, after spatial arrangement of the circuit board assembly 220 and the battery 222 is performed on the rigid bracket 221, the circuit board assembly 220 and the battery 222 are further disposed in the accommodation cavity 2101 through the rigid bracket 221. In this way, a probability of damage to the circuit board assembly 220 and the battery 222 during the assembly process can be effectively reduced, thereby effectively improving the production yield of the earphone 1. It should be noted that in some embodiments, the circuit board assembly 220 is also referred to as a main control circuit board.

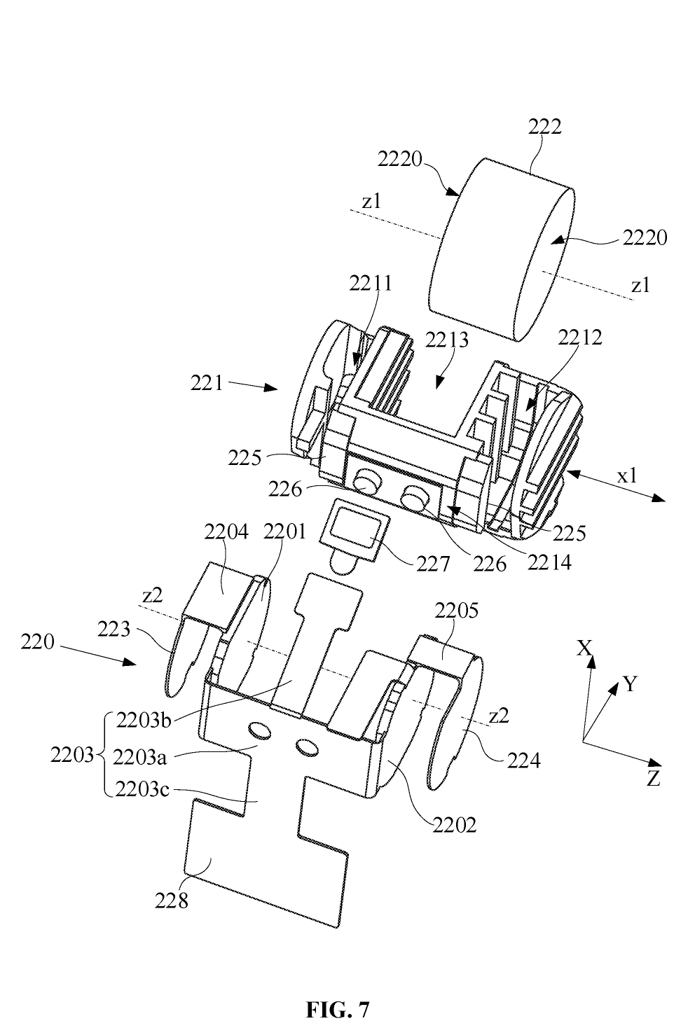

Optionally, as shown in FIGS. 6 and 7, in some embodiments, the circuit board assembly 220 includes a rigid circuit board (for example, a first rigid circuit board 2201 or a second rigid circuit board 2202 shown in FIGS. 6 and 7). The rigid circuit boards are plate-like structures of the circuit board assembly 220 configured to integrate circuit elements. The circuit elements may include a main control circuit, sensors, or the like. The circuit board assembly 220 may be provided with at least one rigid circuit board to effectively improve an integration degree of the circuit elements of the earphone 1, thereby effectively improving space utilization of the earphone 1 while ensuring functional diversity of the earphone 1. In some embodiments, the rigid bracket 221 is provided with a battery accommodation region 2213 and at least one circuit board accommodation region. The battery accommodation region 2213 has a second opening (not shown), and the circuit board accommodation region has a third opening (not shown). The rigid circuit board and the battery 222 are respectively disposed in the circuit board accommodation region and the battery accommodation region 2213 of the rigid bracket 221. Such an arrangement enables the rigid bracket 221 to provide better physical protection for the rigid circuit board and the battery 222, so as to effectively protect circuit elements on the rigid circuit board and the battery 222, thereby effectively reducing a probability of damage to the circuit board assembly 220 and the battery 222 during an assembly process, and further effectively improving production yield of the earphone 1. The rigid circuit board and the battery 222 are separately disposed in the battery accommodation region 2213 and the circuit board accommodation region, respectively. In this way, heat dissipation efficiency of the battery 222 and the rigid circuit board can also be effectively improved, thereby effectively improving the working stability of the battery 222 and circuit elements on the rigid circuit board.

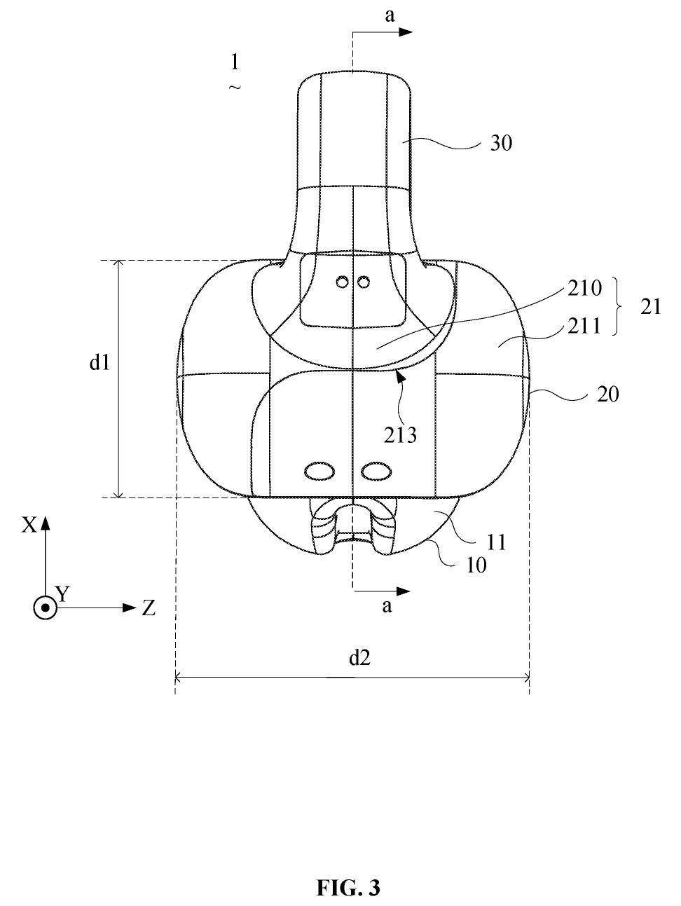

As shown in FIGS. 2 and 3, the ear hook part 30 has a symmetry plane a-a provided along a length direction of the ear hook part 30, and has an x1 direction perpendicular to the symmetry plane a-a. The x1 direction is parallel to a z-axis in the figure. The battery accommodation region 2213 and at least one circuit board accommodation region are spaced apart from each other along the x1 direction. The second opening and the third opening are configured to allow the battery 222 and the rigid circuit board to be placed in the battery accommodation region 2213 and the circuit board accommodation region, respectively, along a direction perpendicular to the x1 direction. Such an arrangement can effectively avoid interference of a spatial position of the battery accommodation region 2213 with an installation process of the rigid circuit board, and avoid interference of a spatial position of the circuit board accommodation region with an installation process of the battery 222, thereby effectively improving assembly efficiency of the battery 222 and the rigid circuit board.

Preferably, as shown in FIGS. 6 and 7, in some embodiments, the circuit board assembly 220 may include two or more rigid circuit boards, and the corresponding rigid bracket 221 is formed with two or more circuit board accommodation regions spaced apart along the x1 direction. The two or more rigid circuit boards are respectively disposed in corresponding circuit board accommodation regions. In this way, heat dissipation efficiency of each rigid circuit board is effectively improved, thereby improving the stability of circuit elements on each rigid circuit board. For example, in the present embodiment, the circuit board assembly 220 includes two rigid circuit boards, which are a first rigid circuit board 2201 and a second rigid circuit board 2202. Correspondingly, the rigid bracket 221 is formed with two circuit board accommodation regions spaced apart along the x1 direction, i.e., a first circuit board accommodation region 2211 and a second circuit board accommodation region 2212. The first rigid circuit board 2201 and the second rigid circuit board 2202 are respectively disposed in the first circuit board accommodation region 2211 and the second circuit board accommodation region 2212. In this way, the working stability of circuit elements on the first rigid circuit board 2201 and circuit elements on the second rigid circuit board 2202 is effectively improved.

It should be noted that, unless otherwise specified herein, the rigid circuit board may refer to either the first rigid circuit board 2201 or the second rigid circuit board 2202. The corresponding circuit board accommodation region may refer to either the first circuit board accommodation region 2211 or the second circuit board accommodation region 2212. In some embodiments, the first rigid circuit board 2201 is also referred to as a first board body, and the second rigid circuit board 2202 is also referred to as a second board body.

Preferably, as shown in FIG. 7, in some embodiments, the battery 222 is arranged in a columnar shape. For example, the battery 222 may be a prismatic body having a square or rectangular bottom surface, or a cylindrical body having a circular bottom surface. An axial direction z1 of the battery 222 is defined as an extending direction perpendicular to the bottom surface of the columnar body. For example, in the present embodiment, the battery 222 is arranged in a cylindrical shape, and the axial direction z1 is defined as an extending direction perpendicular to an end surface 2220 of the battery 222. Furthermore, an angle between the x1 direction and an axial direction z1 of the battery 222 is set to be greater than or equal to 0° and less than or equal to 30°. In this way, the x1 direction and the axial direction z1 of the battery 222 are arranged to be as parallel as possible, thereby effectively improving space utilization of the rigid bracket 221 while effectively reducing a spatial volume of the rigid bracket 221, and further effectively reducing a spatial volume of the embedded body 22. Furthermore, the rigid circuit board has a substantially planar main surface configured to dispose circuit elements, and has a maximum dimension in an extending direction of the main surface. The main surface of the rigid circuit board is disposed facing toward or away from an end surface 2220 of the battery 222. Such an arrangement can effectively reduce the space occupation of the rigid circuit board and the battery 222 in the x1 direction, thereby effectively improving space utilization of the rigid bracket 221, and further effectively reducing the spatial volume of the embedded body 22.

Optionally, as shown in FIG. 7, in some embodiments, an angle between the main surface of the rigid circuit board and the x1 direction is greater than or equal to 80° and less than or equal to 90°. In this way, the main surface of the rigid circuit board is enabled to be disposed as perpendicular to the x1 direction as possible, thereby reducing the space occupation of the rigid circuit board and the battery 222 in the x1 direction, thereby effectively improving space utilization of the rigid bracket 221, and further effectively reducing the spatial volume of the embedded body 22.

Preferably, as shown in FIG. 7, in some embodiments, an angle between the normal direction z2 of the main surface of the rigid circuit board and the axial direction z1 of the battery 222 is set to be less than or equal to 7°. In this way, the normal direction z2 and the axial direction z1 of the battery 222 are arranged to be as parallel as possible, thereby reducing the space occupation of the rigid circuit board and the battery 222 in the x1 direction, thereby effectively improving the space utilization of the rigid bracket 221, and further effectively reducing the spatial volume of the embedded body 22.

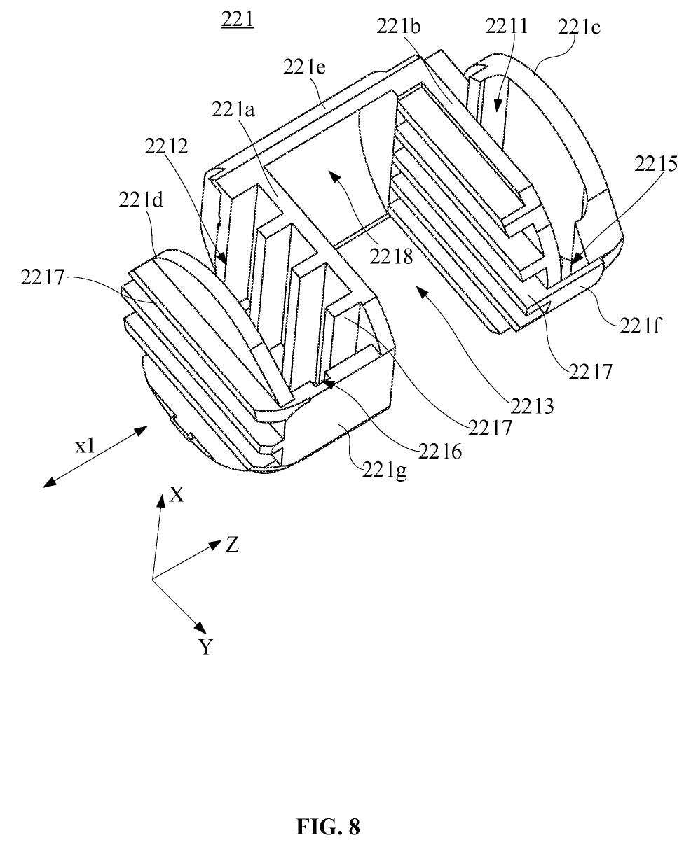

Optionally, as shown in FIG. 8, in some embodiments, the rigid bracket 221 may be formed by connecting a plurality of plate-like members. In this way, the structural strength of the rigid bracket 221 is ensured while the overall weight of the rigid bracket 221 is effectively reduced, and the overall weight of the earphone 1 is further effectively reduced. Specifically, in some embodiments, the rigid bracket 221 includes a first end plate 221a, a second end plate 221b, a third end plate 221c, a fourth end plate 221d, a first side plate 221e, a second side plate 221f, and a third side plate 221g. The first end plate 221a, the second end plate 221b, and the third end plate 221c are sequentially spaced apart along the x1 direction, and the third end plate 221c is located on a side of the second end plate 221b away from the first end plate 221a. The first side plate 221e connects the first end plate 221a and the second end plate 221b, so as to form a battery accommodation region 2213 between the first end plate 221a and the second end plate 221b. The second side plate 221f connects the second end plate 221b and the third end plate 221c, so as to form a first circuit board accommodation region 2211 between the second end plate 221b and the third end plate 221c. The fourth end plate 221d is located on a side of the first end plate 221a away from the second end plate 221b, and is spaced apart from the first end plate 221a along the x1 direction. The third side plate 221g connects the fourth end plate 221d and the first end plate 221a, so as to form a second circuit board accommodation region 2212. In this way, the structural strength of the rigid bracket 221 is ensured while the overall weight of the rigid bracket 221 is effectively reduced.

Preferably, the rigid bracket 221 is a one-piece molded part as shown in FIG. 8, i.e., the rigid bracket 221 may be made by a one-piece molding process. A plurality of rib structures 2217 may be provided on side walls of the first end plate 221a, the second end plate 221b, the third end plate 221c, and the fourth end plate 221d along the x1 direction, respectively. In this way, the rib structures 2217 effectively improve the structural strength of the first end plate 221a, the second end plate 221b, the third end plate 221c, and the fourth end plate 221d. In addition, the first end plate 221a, the second end plate 221b, the third end plate 221c, and the fourth end plate 221d are plate-like structures. After the integral forming process is completed, the first end plate 221a, the second end plate 221b, the third end plate 221c, and the fourth end plate 221d need to be cooled, and the rib structures 2217 may effectively improve heat dissipation uniformity of the first end plate 221a, the second end plate 221b, the third end plate 221c, and the fourth end plate 221d, thereby effectively preventing defects such as excessive deformation and collapse during cooling of the first end plate 221a, the second end plate 221b, the third end plate 221c, and the fourth end plate 221d, and further effectively improving production yield of the rigid bracket 221.

Preferably, as shown in FIGS. 6-8, in some embodiments, a projection of the first end plate 221a and a projection of the second end plate 221b along the axial direction z1 of the battery 222 overlap with the end surface 2220 of the battery 222. In this way, the space occupation of the battery 222 with respect to the rigid bracket 221 in the x1 direction is effectively reduced, thereby effectively reducing the overall volume of the rigid bracket 221. Furthermore, in a reference cross-section perpendicular to the axial direction z1 of the battery 222, an inner side 2218 of the first side plate 221e is arranged in an arc shape adapted to an outer circumferential surface of the battery 222. In this way, the inner side 2218 of the first side plate 221e can closely fit the outer circumferential surface of the battery 222, thereby effectively improving connection stability between the battery 222 and the first side plate 221e.

Optionally, as shown in FIGS. 6-8, in some embodiments, an inner side of the second side plate 221f is provided with a first embedded groove 2215, and an inner side of the third side plate 221g is provided with a second embedded groove 2216. The first rigid circuit board 2201 is embedded in the first embedded groove 2215, and the second rigid circuit board 2202 is embedded in the second embedded groove 2216. In this way, the first rigid circuit board 2201 and the second rigid circuit board 2202 are respectively fixedly connected to the second side plate 221f and the third side plate 221g via the first embedded groove 2215 and the second embedded groove 2216, thereby effectively improving connection stability of the first rigid circuit board 2201 and the second rigid circuit board 2202 with the rigid bracket 221, effectively reducing a probability of vibration of the first rigid circuit board 2201 and the second rigid circuit board 2202, and further effectively improving working stability of the circuit board assembly 220.

Preferably, in some embodiments, a spacing distance between the second end plate 221b and the third end plate 221c is greater than a spacing distance between the first end plate 221a and the fourth end plate 221d. In this way, circuit elements with larger space occupation in the x1 direction may be integrated on the first rigid circuit board 2201, and circuit elements with smaller space occupation in the x1 direction may be integrated on the second rigid circuit board 2202, thereby effectively improving space utilization of the rigid bracket 221 along the x1 direction and effectively reducing the spatial volume of the rigid bracket 221.

Preferably, as shown in FIGS. 6 and 7, the circuit board assembly 220 further includes a first flexible circuit board 2203 connecting the first rigid circuit board 2201 and the second rigid circuit board 2202. In some embodiments, circuit elements on the first rigid circuit board 2201 may be electrically connected to circuit elements on the second rigid circuit board 2202 via the first flexible circuit board 2203, so as to realize information interaction or the like between the corresponding circuit elements. The first flexible circuit board 2203 is attached to a side of the first side plate 221e away from the battery accommodation region 2213. In this way, the first side plate 221e provides rigid support for the first flexible circuit board 2203, effectively reducing the probability of damage to the first flexible circuit board 2203, and further effectively improving the working stability of the circuit board assembly 220.

Preferably, in some embodiments, a grounding point is further provided on the first rigid circuit board 2201 or the second rigid circuit board 2202, where the first rigid circuit board 2201 and the second rigid circuit board 2202 are connected to a common ground via the first flexible circuit board 2203. For example, in some embodiments, the first rigid circuit board 2201 is provided with a radio frequency unit configured to transmit radio frequency signals, where the radio frequency unit serves as a connecting component of the antenna assembly, with details provided in the following description. The second rigid circuit board 2202 is provided with a grounding point.

It should be noted that in some embodiments, the first flexible circuit board 2203 is also referred to as a flexible connection board.

Preferably, as shown in FIGS. 6 and 7, in some embodiments, along the axial direction z1 of the battery 222, the first rigid circuit board 2201 and the second rigid circuit board 2202 are arranged at intervals at two ends of the battery 222. For example, as described above, the first rigid circuit board 2201 and the second rigid circuit board 2202 are respectively disposed in the first circuit board accommodation region 2211 and the second circuit board accommodation region 2212. In this way, an area of the first rigid circuit board 2201 and an area of the second rigid circuit board 2202 (i.e., an area of the main surface for disposing circuit elements, which is also referred to as an area of the rigid circuit board in some embodiments) are effectively ensured. As a result, the circuit board assembly 220 may integrate more circuit elements while effectively improving the space utilization of the battery 222 and the circuit board assembly 220.

Furthermore, a projection of the first rigid circuit board 2201 and the second rigid circuit board 2202 along the axial direction z1 of the battery 222 at least partially overlap with an end surface 2220 of the battery 222, and a projection of the first flexible circuit board 2203 along a radial direction of the battery 222 at least partially overlaps with a circumferential surface of the battery 222. In this way, the space utilization of the battery 222 and the circuit board assembly 220 is further improved.

Preferably, as shown in FIGS. 6 and 7, in some embodiments, a ratio of an area of the first rigid circuit board 2201 to a total projection area of the first rigid circuit board 2201 along the axial direction z1 of the battery 222 is greater than or equal to 80%, and a ratio of an overlapping area of the second rigid circuit board 2202 with the end surface 2220 of the battery 222 to a total projection area of the second rigid circuit board 2202 along the axial direction z1 of the battery 222 is greater than or equal to 80%. In this way, space utilization between the rigid circuit board and the battery 222 is effectively improved. Preferably, in some embodiments, an area of the rigid circuit board may be equal to a total projection area of the rigid circuit board along the axial direction z1 of the battery 222, i.e., a ratio of the area of the rigid circuit board to the total projection area of the rigid circuit board along the axial direction z1 of the battery 222 is equal to 1.

Preferably, as shown in FIGS. 6 and 7, in some embodiments, an angle between a normal direction z2 of a main surface of the first rigid circuit board 2201 and the axial direction z1 of the battery 222 and an angle between a normal direction z2 of a main surface of the second rigid circuit board 2202 and the axial direction z1 of the battery 222 are both less than or equal to 10°. In this way, the main surface of the first rigid circuit board 2201 and the main surface of the second rigid circuit board 2202 are arranged to be as parallel as possible to two end surfaces of the battery 222, respectively, thereby effectively improving space utilization among the first rigid circuit board 2201, the second rigid circuit board 2202, and the battery 222. Specifically, the rigid circuit board is disposed in a plate-like shape, and a main surface of the rigid circuit board refers to either of two side surfaces thereof, i.e., a size of the main surface of the rigid circuit board is a maximum dimension of the rigid circuit board in its extending direction, therefore, arranging the main surface of the rigid circuit board to be as parallel as possible to the end surface 2220 of the battery 222 can effectively improve space utilization between the rigid circuit board and the battery 222.

Optionally, as shown in FIGS. 6 and 7, in some embodiments, the earphone 1 further includes a microphone 227 and a wearing detection electrode 228 disposed in the accommodation cavity 2101. The microphone 227 and the wearing detection electrode 228 may be fixedly disposed relative to the rigid bracket 221 and serve as a part of the embedded body 22, and are embedded into the accommodation cavity 2101 in the manner described above. In this way, the assembly efficiency of the earphone 1 is effectively improved. Specifically, in the present embodiment, the first flexible circuit board 2203 further includes a main circuit board 2203a extending along the axial direction z1 of the battery 222 and connecting the first rigid circuit board 2201 and the second rigid circuit board 2202, and the first flexible circuit board 2203 further includes a first branch circuit board 2203c and a second branch circuit board 2203b.One end of the first branch circuit board 2203c and one end of the second branch circuit board 2203b are respectively located on two opposite sides of the main circuit board 2203a along the circumferential direction of the battery 222. In this way, the first branch circuit board 2203c and the second branch circuit board 2203b serve as additional circuit boards of the first flexible circuit board 2203, so as to improve functionality of the first flexible circuit board 2203. Meanwhile, since the first branch circuit board 2203c and the second branch circuit board 2203b are respectively located along the circumferential direction of the battery 222, space utilization between the first flexible circuit board 2203 and the battery 222 is effectively improved. Furthermore, the other end of the first branch circuit board 2203c is connected to the wearing detection electrode 228, so that the wearing detection electrode 228 is connectable to a corresponding circuit element (e.g., a wearing detection circuit) on the rigid circuit board, thereby realizing a wearing detection function of the earphone 1. The other end of the second branch circuit board 2203b is connected to the microphone 227, so that the microphone 227 is connectable to a corresponding circuit element (e.g., a microphone processing circuit) on the rigid circuit board, thereby realizing a microphone function of the earphone 1.

Preferably, as shown in FIGS. 6 and 7, in some embodiments, while the first branch circuit board 2203c serves as a part of the first flexible circuit board 2203, an end of the first branch circuit board 2203c away from the main circuit board 2203a extends to form a wearing detection electrode 228 configured to acquire a wearing detection signal. In this way, a portion of the first branch circuit board 2203c serves as the wearing detection electrode 228, thereby effectively improving the part reuse rate of the earphone 1, further effectively simplifying the overall structure of the earphone 1, and effectively reducing the manufacturing cost of the earphone 1.

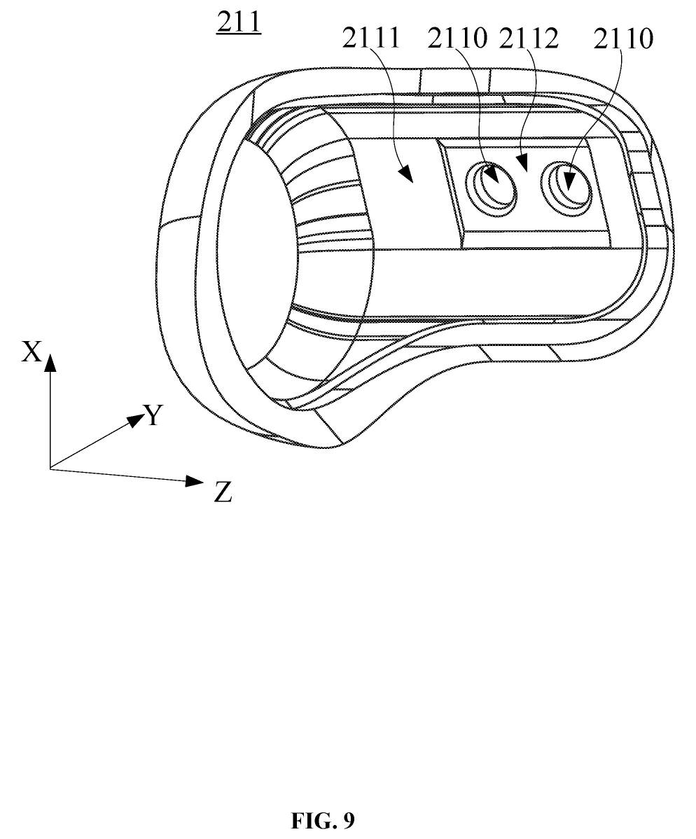

Optionally, as shown in FIGS. 5, 6, 7, and 9, in some embodiments, the embedded body 22 further includes an electrode terminal 226 configured to supply power to the battery 222. The battery 222 is connected to the electrode terminal 226, so that the battery 222 is chargeable by being connected to a charging case of the earphone 1 via the electrode terminal 226, thereby realizing charging of the battery 222. The second housing 211 is provided with a connection through hole 2110, and the electrode terminal 226 is exposed through the connection through hole 2110, so that when the earphone 1 is accommodated in the charging case, the electrode terminal 226 electrically connects the battery 222 with the charging case. The first side plate 221e is arranged opposite to the connection through hole, and the electrode terminal 226 is disposed on the first side plate 221e. In this way, the first side plate 221e supports the electrode terminal 226 in the accommodation cavity 2101, thereby improving connection stability of the electrode terminal 226 with the second housing 211, and preventing relative positional changes between the electrode terminal 226 and the second housing 211 caused by external factors such as a drop of the earphone 1, which may otherwise lead to poor contact between the electrode terminal 226 and the charging case.

Preferably, as shown in FIGS. 5, 6, 7, and 9, in some embodiments, an inner side of the second housing 211 is provided with a first platform 2111 configured as a planar surface, and the connection through hole 2110 is disposed in the first platform 2111, a side of the first side plate 221e facing the first platform 2111 is provided with a second platform 2214 corresponding to the first platform 2111 and configured as a planar surface, the electrode terminal 226 is disposed on the second platform 2214, and the first platform 2111 and the second platform 2214 are attached to each other. After the electrode terminal 226 passes through the connection through hole 2110, a peripheral region of the connection through hole 2110 needs to be sealed, so as to prevent sweat, rainwater, or impurities such as dust from entering the accommodation cavity 2101 through a gap between the connection through hole 2110 and the electrode terminal 226. Therefore, the first side plate 221e is attached to the inner side of the second housing 211 via the second platform 2214 and the first platform 2111. In this way, a region between the second housing 211 and the first side plate 221e is better sealed, thereby effectively improving the sealing performance of the accommodation cavity 2101, and further effectively improving the working stability of the circuit board assembly 220 and the battery 222. Optionally, in some embodiments, a double-sided adhesive may be used to seal a region between the second housing 211 and the first side plate 221e. For example, after the double-sided adhesive is adhered to the first platform 2111, the first platform 2111 with the double-sided adhesive is pressed against the second platform 2214, thereby realizing sealing.

Optionally, as shown in FIGS. 5, 6, 7, and 9,in some embodiments, a dispensing method may also be used to seal a region between the second housing 211 and the first side plate 221e. The inner side of the second housing 211 is further provided with a glue-containing groove 2112 located in the first platform 2111 and surrounding the connection through hole 2110. The glue-containing groove 2112 is configured to be filled with sealant, so that after the first platform 2111 on the inner side of the second housing 211 is attached to the second platform 2214, the sealant overflows and seals the first platform 2111 and the second platform 2214, thereby effectively improving sealing convenience between the second housing 211 and the first side plate 221e, and further effectively preventing the sealant from dripping onto the circuit board assembly 220 or the battery 222, which would otherwise affect performance of the circuit board assembly 220 and the battery 222.

In some embodiments, the main surface of the main circuit board 2203a is arranged opposite to the connection through hole 2110. The main circuit board 2203a is connected to the electrode terminal 226 so as to be connected with the battery 222, and at least a portion of the main circuit board 2203a is clamped between the first platform 2111 and the second platform 2214. In this way, the sealing performance of the accommodation cavity 2101 is effectively improved.

Preferably, as shown in FIGS. 6 and 7, in some embodiments, the embedded body 22 further includes two magnetic members 225 disposed on two sides of the electrode terminal 226. When the earphone 1 is placed into the charging case, the two magnetic members 225 are magnetically engaged with corresponding magnetic members in the charging case, so that the electrode terminal 226 is accurately connected to a charging electrode in the charging case, while effectively improving the connection stability between the electrode terminal 226 and the charging electrode.

Optionally, as shown in FIGS. 6 and 7, in some embodiments, the two magnetic members 225 may be fixed on the first side plate 221e. Specifically, a side of the first side plate 221e away from the battery accommodation region 2213 is provided with two fixing portions spaced apart along the x1 direction (not shown), and the two magnetic members 225 are respectively disposed on the fixing portions, thereby improving connection stability between the magnetic members 225 and the rigid bracket 221. Optionally, in other embodiments, a fixing portion is respectively formed on the first end plate 221a and the second end plate 221b, and the two magnetic members 225 may also be respectively disposed on the first end plate 221a and the second end plate 221b. Or, in some embodiments, the two fixing portions are respectively formed at a connection between the first side plate 221e and the first end plate 221a and a connection between the first side plate 221e and the second end plate 221b.

Optionally, as shown in FIGS. 6 and 7, in some embodiments, the earphone 1 further includes an antenna assembly 2230. The antenna assembly 2230 is disposed in the accommodation cavity 2101, and the antenna assembly 2230 is connected to a radio frequency unit configured to transmit radio frequency signals, so as to realize transmission or reception of antenna signals. Preferably, in some embodiments, the antenna assembly 2230 is fixed to the rigid bracket 221 so as to serve as a part of the embedded body 22, and is embedded into the accommodation cavity 2101 in the manner described above, thereby effectively improving assembly efficiency of the earphone 1. The radio frequency unit may be disposed on the rigid circuit board, so as to effectively improve the space utilization of the earphone 1.

Preferably, as shown in FIGS. 6 and 7, in some embodiments, the antenna assembly 2230 is spaced apart from the battery 222 by a preset interval distance along the axial direction z1 of the battery 222. In this way, space utilization between the battery 222 and the antenna assembly 2230 is effectively improved, while interference of the battery 222 with the antenna assembly 2230 is effectively reduced, thereby effectively improving the performance of the antenna assembly 2230. Furthermore, a projection of the antenna assembly 2230 along the axial direction z1 of the battery 222 at least partially overlaps with the end surface 2220 of the battery 222. In this way, a space occupancy rate of the antenna assembly 2230 in the radial direction of the battery 222 is effectively reduced, thereby effectively improving space utilization of the antenna assembly 2230 and the battery 222.

Preferably, as shown in FIGS. 6 and 7, the antenna assembly 2230 includes a first antenna part 223 and a second antenna part 224, where the first antenna part 223 and the second antenna part 224 are configured to be connected to the radio frequency unit separately or simultaneously, so as to transmit antenna signals separately or simultaneously. In this way, working stability and antenna performance of the antenna assembly 2230 are effectively improved.

Preferably, in some embodiments, the first antenna part 223 is connected to a radio frequency port of the radio frequency unit, and the second antenna part 224 is grounded (or connected to a grounding point). The radio frequency unit simultaneously transmits or receives signals (antenna signals) through the first antenna part 223 and the second antenna part 224. In this way, a circuit structure between the first antenna part 223, the second antenna part 224, and the radio frequency unit is effectively simplified, and after being grounded, the second antenna part 224 further serves as an antenna branch of the first antenna part 223, and transmits or receives signals simultaneously with the first antenna part 223, thereby further improving antenna performance of the antenna assembly 2230. Furthermore, after the second antenna part 224 is grounded, the current concentrated on the first antenna part 223 is effectively dispersed, thereby preventing the current generated based on radio frequency signals from being completely concentrated on the first antenna part 223, and further effectively reducing the Specific Absorption Rate (SAR) value of the antenna assembly 2230. Moreover, in the present embodiment, the earphone 1 includes a left earphone and a right earphone, and the left earphone and the right earphone are wearable in a manner of being interchangeable between the left ear and the right ear. When the left earphone and the right earphone are interchanged, a relative position of the first antenna part 223 and the second antenna part 224 along a gravity direction changes, thereby affecting a clearance rate of the first antenna part 223 and/or the second antenna part 224, and further affecting antenna performance of the first antenna part 223 and/or the second antenna part 224. Therefore, the first antenna part 223 and the second antenna part 224 are respectively connected to the radio frequency port and the grounding point of the radio frequency unit in the manner described above, so that even when the left earphone and the right earphone are interchanged, one of the first antenna part 223 and the second antenna part 224 is ensured to be located at a position with a better clearance rate and continues to operate, thereby effectively ensuring stability of antenna functions of the antenna assembly 2230, while further ensuring realization of a left-right earphone interchange function of the earphone 1.

Optionally, in some embodiments, the earphone 1 further includes a switching element (not shown), a detecting element (not shown), and a control circuit (not shown), where the detecting element is configured to detect working indicators of the antenna assembly 2230, such as a current radiation efficiency of the antenna assembly 2230, or the detecting element is further configured to detect a relative positional relationship between the first antenna part 223 and the second antenna part 224, such as a spatial relative positional relationship between the first antenna part 223 and the second antenna part 224 along a gravity direction. In this way, the control circuit is configured to control the switching element to selectively connect one of the first antenna part 223 and the second antenna part 224 to the radio frequency port of the radio frequency unit according to a detection result of the detecting element, so that one of the first antenna part 223 and the second antenna part 224 having a better clearance rate or better radiation efficiency transmits or receives signals, thereby effectively improving working stability and antenna performance of the antenna assembly 2230. For example, in the present embodiment, the earphone 1 includes the left earphone and the right earphone, and the left earphone and the right earphone are wearable in a manner of realizing a left-right ear interchange function. When the left earphone and the right earphone are interchanged, a relative position of the first antenna part 223 and the second antenna part 224 changes, and when a detection result of the detecting element indicates that the first antenna part 223 is located above the second antenna part 224, the first antenna part 223 has a better clearance rate. Then the control circuit connects the first antenna part 223 to the radio frequency port of the radio frequency unit based on the detection result, so that the radio frequency unit transmits or receives antenna signals through the first antenna part 223, thereby effectively improving antenna performance and working stability of the antenna assembly 2230. Optionally, in some embodiments, the detecting element may include a gravity sensing element and other detecting components, the switching element may be a logic switch and other components, and the control circuit may be a circuit having certain logic control capability, such as the main control circuit of the earphone 1 or an independent logic processing circuit. The control circuit is respectively connected to the switching element and the detecting element, so as to realize that the switching element is controlled based on the detection result of the detecting element to selectively connect one of the first antenna part 223 and the second antenna part 224 to the radio frequency port of the radio frequency unit. Optionally, in some embodiments, the above functional logic of the switching element, the detecting element, and the control circuit may also be independently implemented by the main control circuit of the earphone.

Preferably, in some embodiments, an antenna structure of the first antenna part 223 is the same as an antenna structure of the second antenna part 224. In this way, when a relative positional relationship between the first antenna part 223 and the second antenna part 224 changes, the first antenna part 223 or the second antenna part 224 located at a position with a better clearance rate still efficiently realizes antenna functions, thereby effectively improving stability of the antenna assembly 2230, and further effectively ensuring consistency of antenna performance of the antenna assembly 2230 after the earphone 1 is switched from one side ear to the other side ear for wearing.

Preferably, in some embodiments, the first antenna part 223 has a first antenna length, and the second antenna part 224 has a second antenna length, where a ratio of the first antenna length to the second antenna length is less than or equal to 1.2 and greater than or equal to 0.8. In this way, the first antenna length and the second antenna length are ensured to be as equal as possible, so as to improve similarity between the first antenna part 223 and the second antenna part 224, and further effectively ensure consistency of antenna performance of the antenna assembly 2230 after the earphone 1 is switched from one side ear to the other side ear for wearing.

Preferably, in some embodiments, the switching element, the detecting element, and the control circuit may be integrated on the first rigid circuit board 2201 or the second rigid circuit board 2202, thereby effectively improving space utilization of the earphone 1.

Furthermore, as shown in FIGS. 6 and 7, the first antenna part 223 and the second antenna part 224 are arranged at intervals at two ends of the battery 222 along the axial direction z1 of the battery 222, and projections of the first antenna part 223 and the second antenna part 224 along the axial direction z1 of the battery 222 respectively at least partially overlap with the end surfaces 2220 of the battery 222. In this way, a space occupancy rate of the first antenna part 223 and the second antenna part 224 in the radial direction of the battery 222 is effectively reduced, thereby effectively improving space utilization of the antenna assembly 2230 and the battery 222.

Preferably, in some embodiments, projections of the first antenna part 223 and the second antenna part 224 in the radial direction of the battery 222 do not overlap with the battery 222, i.e., the first antenna part 223 and the second antenna part 224 are entirely located at two ends of the battery 222 along the axial direction z1. In this way, the first antenna part 223 and the second antenna part 224 are entirely kept at a greater interval distance from the battery 222, so as to effectively reduce interference of the battery 222 with the antenna assembly 2230, thereby improving the clearance rate of the antenna assembly 2230, while effectively reducing a space occupancy rate of the first antenna part 223 and the second antenna part 224 in the radial direction of the battery 222, and further effectively improving space utilization of the antenna assembly 2230 and the battery 222.

Preferably, as shown in FIGS. 6 and 7, in some embodiments, in the wearing state, the axial direction z1 of the battery 222 is arranged to intersect with the horizontal plane of the human body. In this way, in the wearing state, a probability that the first antenna part 223 and the second antenna part 224 are shielded by the head of the user is minimized as much as possible, thereby effectively improving clearance rates of the first antenna part 223 and the second antenna part 224, and further effectively improving antenna performance of the antenna assembly 2230. Preferably, in some embodiments, in the wearing state, the axial direction z1 of the battery 222 may be arranged perpendicular to the horizontal plane of the human body, so as to further improve antenna performance of the antenna assembly 2230.

Preferably, as shown in FIGS. 6 and 7, in some embodiments, a ratio of an area of the first antenna part 223 to the total projection area of the first antenna part 223 along the axial direction z1 of the battery 222 is greater than or equal to 1.2, and a ratio of an area of the second antenna part 224 to the total projection area of the second antenna part 224 along the axial direction z1 of the battery 222 is greater than or equal to 1.2. In this way, a space occupancy rate of the first antenna part 223 and the second antenna part 224 in the radial direction of the battery 222 is effectively reduced, thereby effectively improving space utilization among the first antenna part 223, the second antenna part 224, and the battery 222.

Preferably, in some embodiments, an area of the first antenna part 223 may be equal to the total projection area of the first antenna part 223 along the axial direction z1 of the battery 222, i.e., the ratio of the area of the first antenna part 223 to the total projection area of the first antenna part 223 along the axial direction z1 of the battery 222 is equal to 1. The area of the second antenna part 224 may be equal to the total projection area of the second antenna part 224 along the axial direction z1 of the battery 222, i.e., the ratio of the area of the second antenna part 224 to the total projection area of the second antenna part 224 along the axial direction z1 of the battery 222 is equal to 1.

Preferably, as shown in FIGS. 6 and 7, in some embodiments, the first antenna part 223 and the second antenna part 224 are respectively arranged in a sheet shape, the main surface of the first antenna part 223 is a maximum extension surface of the first antenna part 223, and the main surface of the second antenna part 224 is a maximum extension surface of the second antenna part 224. The main surface of the first antenna part 223 and the main surface of the second antenna part 224 are respectively arranged facing toward or away from the end surfaces 2220 of the battery 222. In this way, a space occupancy rate of the first antenna part 223 and the second antenna part 224 along the axial direction z1 of the battery 222 is effectively reduced.

Furthermore, an angle between a normal direction of the main surface of the first antenna part 223 and the axial direction z1 of the battery 222, and an angle between a normal direction of the main surface of the second antenna part 224 and the axial direction z1 of the battery 222 are respectively less than or equal to 10 degrees. In this way, the main surface of the first antenna part 223 and the main surface of the second antenna part 224 are respectively arranged to be as parallel as possible to be adjacent to the end surfaces 2220 of the battery 222, thereby further improving space utilization among the battery 222, the first antenna part 223, and the second antenna part 224. For example, in some embodiments, the angle between the normal direction of the main surface of the first antenna part 223 and the axial direction z1 of the battery 222 and the angle between the normal direction of the main surface of the second antenna part 224 and the axial direction z1 of the battery 222 may be set to 0°. Preferably, in some embodiments, the normal direction of the main surface of the first antenna part 223 and the normal direction of the main surface of the second antenna part 224 are respectively arranged parallel to the normal direction z2, in other embodiments, the normal direction of the main surface of the first antenna part 223 and the normal direction of the main surface of the second antenna part 224 may also be respectively arranged to form an angle with the normal direction z2.

Preferably, as shown in FIGS. 6-8, in some embodiments, the first antenna part 223 is arranged at intervals along the axial direction z1 of the battery 222 on a side of the first rigid circuit board 2201 away from the battery 222, and the second antenna part 224 is arranged at intervals along the axial direction z1 of the battery 222 on a side of the second rigid circuit board 2202 away from the battery 222. In this way, the first rigid circuit board 2201 and the second rigid circuit board 2202 effectively separate the first antenna part 223 and the second antenna part 224 from the battery 222 respectively, thereby effectively reducing interference of the battery 222 with the first antenna part 223 and the second antenna part 224, and further effectively improving operational stability and antenna performance of the antenna assembly 2230. Furthermore, in some embodiments, the first antenna part 223 is disposed on a side of the third end plate 221c away from the first circuit board accommodation region 2211, and the second antenna part 224 is disposed on a side of the fourth end plate 221d away from the second circuit board accommodation region 2212. In this way, clearance rates of the first antenna part 223 and the second antenna part 224 are effectively improved, while interference of the battery 222 with the first antenna part 223 and the second antenna part 224 is further reduced, thereby effectively improving operational stability and antenna performance of the antenna assembly 2230.

Optionally, as shown in FIGS. 6 and 7, in some embodiments, the circuit board assembly 220 further includes a second flexible circuit board 2204 connected to the first rigid circuit board 2201 and a third flexible circuit board 2205 connected to the second rigid circuit board 2202. The second flexible circuit board 2204 is further connected to the first antenna part 223, and the third flexible circuit board 2205 is further connected to the second antenna part 224. The second flexible circuit board 2204 provides circuit routing for the first antenna part 223, so that the first antenna part 223 is connected to the radio frequency unit on the rigid circuit board, and the third flexible circuit board 2205 provides circuit routing for the second antenna part 224, so that the second antenna part 224 is connected to the radio frequency unit on the rigid circuit board. In this way, the connection convenience between the first antenna part 223 and the second antenna part 224, and the circuit board assembly 220 is effectively improved. Preferably, in some embodiments, one end of the second flexible circuit board 2204 away from the first rigid circuit board 2201 extends to form the first antenna part 223 configured to receive or transmit signals, and one end of the third flexible circuit board 2205 away from the second rigid circuit board 2202 extends to form the second antenna part 224 configured to receive or transmit signals. In this way, the second flexible circuit board 2204 and the third flexible circuit board 2205 are respectively reused as the first antenna part 223 and the second antenna part 224, thereby effectively improving the reuse rate of the circuit board assembly 220, effectively simplifying the structure of the earphone 1, and further effectively reducing the manufacturing cost of the earphone 1.

Optionally, in some embodiments, the first antenna part 223 and the second antenna part 224 may be elastic piece structures.

Optionally, in some embodiments, the first antenna part 223 and the second antenna part 224 further act as touch electrodes configured to receive touch signals, thereby effectively improving reuse rates of the first antenna part 223 and the second antenna part 224, effectively simplifying an overall structure of the earphone 1, and further effectively reducing the cost of the earphone 1.

Preferably, as shown in FIGS. 2 and 3, in some embodiments, the sound generation part 10 includes a sound generation component (not shown) and a second housing assembly 211, the second housing assembly 211 being configured to form a second accommodating space (not shown). The sound generation component is disposed in the second accommodating space. The ear hook part 30 connects the first housing assembly 210 and the second housing assembly 211. In the wearing state, the first housing assembly 210 and the second housing assembly 211 form a clamping state on two sides of the helix, and the second housing assembly 211 is located in the cavum conchae. The ear hook part 30 has the symmetry plane a-a arranged along the length direction of the ear hook part 30, and the axial direction z1 of the battery 222 intersects the symmetry plane a-a. In the present embodiment, the earphone 1 is an ear-clip type earphone, and the symmetry plane a-a of the ear hook part 30 serves as the symmetry plane a-a of the earphone 1. In the wearing state, the symmetry plane a-a of the earphone 1 intersects a sagittal plane of the human body, and an angle between the symmetry plane a-a of the earphone 1 and the sagittal plane of the human body is less than or equal to 90° and greater than or equal to 80°. In this way, it is effectively ensured that, in the wearing state, the axial direction z1 of the battery 222 intersects a horizontal plane of the human body, thereby effectively improving a clearance rate of the antenna assembly 2230 and further effectively improving antenna performance of the antenna assembly 2230.

Furthermore, as shown in FIGS. 2 and 3, the earphone 1 is configured as a symmetrical structure with respect to the symmetry plane a-a of the ear hook part 30 (at least referring to an overall appearance profile of the earphone 1). Based on this configuration, the left earphone and the right earphone of the earphone 1 can be interchanged for wearing, and good wearing comfort can be ensured whether the earphone 1 is worn on the left ear or the right ear.

Preferably, as shown in FIGS. 2, 3, 5, and 6, in some embodiments, the antenna structure of the first antenna part 223 is the same as the antenna structure of the second antenna part 224, and the first antenna part 223 and the second antenna part 224 are symmetrically arranged on two sides of the symmetry plane a-a. In this way, when the earphone 1 is worn on a left ear or a right ear, at least one of the first antenna part 223 and the second antenna part 224 can have a good clearance rate, thereby effectively improving the stability of the antenna assembly 2230.

Optionally, as shown in FIG. 3, in some embodiments, a maximum dimension d1 of the first housing assembly 210 parallel to the symmetry plane a-a is smaller than a maximum dimension d2 of the first housing assembly 210 perpendicular to the symmetry plane a-a. In this way, the first housing assembly 210 as a whole can be arranged in a strip columnar shape, and the maximum dimension d2 of the first housing assembly 210 is perpendicular to the symmetry plane a-a, thereby effectively reducing a space occupancy rate of the first housing assembly 210 in the length direction of the ear hook part 30 and further effectively improving an overall space utilization rate of the earphone 1. Furthermore, a joint seam 213 between the first housing 210 and the second housing 211 intersects the symmetry plane a-a. In this way, an opening area of the first opening 2102 of the accommodation cavity 2101 is effectively increased, thereby effectively improving the assembly efficiency of fitting the embedded body 22 into the accommodation cavity 2101.

Optionally, as shown in FIG. 5, in some embodiments, the earphone 1 further includes a soft covering layer. The soft covering layer covers a periphery of the ear hook part 30 to serve as a part of the ear hook part 30, and the soft covering layer further covers at least a part of a periphery of the first housing assembly 210. Specifically, the soft covering layer covers a periphery of the first housing 210 and a periphery of the ear hook part 30. In the wearing state, the first housing 210 abuts against a rear side of an ear through the soft covering layer, thereby effectively improving the wearing comfort of the earphone 1.

Preferably, as shown in FIG. 3, in some embodiments, in the wearing state, the symmetry plane a-a of the earphone 1 intersects the sagittal plane, and an angle between the symmetry plane a-a of the earphone 1 and the sagittal plane is greater than or equal to 80° and less than or equal to 90°. In this way, it is effectively ensured that the axial direction z1 of the battery 222 intersects the horizontal plane, thereby effectively improving clearance rates of the first antenna part 223 and the second antenna part 224 and further improving performance of the antenna assembly 2230.

Preferably, as shown in FIG. 3, in some embodiments, in the wearing state, the symmetry plane a-a of the earphone 1 is arranged perpendicular to the sagittal plane, i.e., an angle between the symmetry plane a-a of the earphone 1 and the sagittal plane is 90°, and the symmetry plane a-a of the earphone 1 is arranged parallel to the horizontal plane. In this way, the clearance rate of the antenna assembly 2230 can be further improved, thereby further improving the performance of the antenna assembly 2230.

The above description is only part of embodiments of the present disclosure and is not intended to limit a scope of protection of the present disclosure. Any equivalent devices or equivalent process transformations made by using contents of the description and drawings of the present disclosure, or directly or indirectly applied to other related technical fields, shall be included in a scope of patent protection of the present disclosure as well.

What is claimed is:

1. An earphone, comprising
a first housing assembly configured to form an accommodation cavity,
a battery, and
a circuit board assembly, the battery and the circuit board assembly being disposed in the accommodation cavity, wherein
the battery is arranged in a columnar shape,
the circuit board assembly includes a first rigid circuit board, a second rigid circuit board, and a first flexible circuit board,
the first rigid circuit board and the second rigid circuit board are arranged at intervals at two ends of the battery along an axial direction of the battery, the first flexible circuit board connects the first rigid circuit board and the second rigid circuit board, a projection of the first rigid circuit board and a projection of the second rigid circuit board along the axial direction of the battery at least partially overlap with an end surface of the battery, and a projection of the first flexible circuit board along a radial direction of the battery at least partially overlaps with a circumferential surface of the battery.

2. The earphone according to claim 1, wherein
a ratio of an area of the first rigid circuit board to a total projection area of the first rigid circuit board along the axial direction of the battery is greater than or equal to 80%, and
a ratio of an area of the second rigid circuit board to a total projection area of the second rigid circuit board along the axial direction of the battery is greater than or equal to 80%.

3. The earphone according to claim 1, wherein
a main surface of the first rigid circuit board is arranged facing toward or away from an adjacent end surface of the battery and a main surface of the second rigid circuit board is arranged facing toward and away from another adjacent end surface of the battery; and
an angle between a normal direction of the main surface of the first rigid circuit board and the axial direction of the battery and an angle between a normal direction of the main surface of the second rigid circuit board and the axial direction of the battery are less than or equal to 10°, respectively.

4. The earphone according to claim 1, wherein
the earphone further comprises a microphone and a wearing detection electrode disposed in the accommodation cavity,
the first flexible circuit board includes a main circuit board extending along the axial direction of the battery and connecting the first rigid circuit board and the second rigid circuit board,
the first flexible circuit board further includes a first branch circuit board and a second branch circuit board, and
one end of the first branch circuit board and one end of the second branch circuit board are located on two opposite sides of the main circuit board along a circumferential direction of the battery, respectively, the other end of the first branch circuit board is connected to the wearing detection electrode, and the other end of the second branch circuit board is connected to the microphone.

5. The earphone according to claim 4, wherein
the first housing assembly is provided with a connection through hole,
the circuit board assembly further includes an electrode terminal configured to supply power to the battery,
a main surface of the main circuit board is arranged opposite to the connection through hole, and
the electrode terminal is connected to the main circuit board and is exposed through the connection through hole.

6. The earphone according to claim 5, wherein
an inner side of the first housing assembly is provided with a first platform configured as a planar surface, and the connection through hole is disposed in the first platform,
the earphone further comprises a rigid bracket disposed in the accommodation cavity, a side of the rigid bracket facing the first platform is provided with a second platform configured as a planar surface, the electrode terminal is disposed in the second platform, and
the first platform and the second platform are attached to each other, and at least a portion of the main circuit board is clamped between the first platform and the second platform.

7. The earphone according to claim 1, wherein
the earphone further comprises a first antenna part and a second antenna part,
the first antenna part is arranged at intervals along the axial direction of the battery on a side of the first rigid circuit board away from the battery,
the second antenna part is arranged at intervals along the axial direction of the battery on a side of the second rigid circuit board away from the battery,
the circuit board assembly further includes a second flexible circuit board connected to the first rigid circuit board and a third flexible circuit board connected to the second rigid circuit board, and
the second flexible circuit board is further connected to the first antenna part, and the third flexible circuit board is further connected to the second antenna part.

8. The earphone according to claim 7, wherein the first antenna part and the second antenna part further act as touch electrodes configured to receive touch signals.

9. The earphone according to claim 7, wherein in a wearing state, the axial direction of the battery intersects a horizontal plane of a human body.

10. The earphone according to claim 9, wherein
the earphone further comprises a second housing assembly, an ear hook part, and a sound generation component,
the sound generation component is disposed in the second housing assembly, and the ear hook part connects the first housing assembly and the second housing assembly,
in the wearing state, the first housing assembly and the second housing assembly form a clamping state on two sides of a helix, the second housing assembly is located in a cavum conchae, the ear hook part has a symmetry plane arranged along a length direction of the ear hook part, and the axial direction of the battery intersects the symmetry plane.

11. The earphone according to claim 10, wherein
the ear hook part has an x1 direction perpendicular to the symmetry plane, an angle between the x1 direction and the axial direction of the battery is set to be greater than or equal to 0° and less than or equal to 30°, and an angle between main surfaces of the first rigid circuit board and the second rigid circuit board and the x1 direction is greater than or equal to 80° and less than or equal to 90°.

12. The earphone according to claim 1, wherein
the first housing assembly includes a first housing, the first housing forms the accommodation cavity having a first opening, the earphone includes an embedded body embedded into the accommodation cavity via the first opening, the embedded body is an assembly of components of the earphone required to be mounted in the accommodation cavity, and components of the earphone required to be mounted in the accommodation cavity at least include the battery and the circuit board assembly.

13. The earphone according to claim 12, wherein
the first housing assembly further includes a second housing, and the second housing cooperates with the first housing to cover the first opening to seal the accommodation cavity.

14. The earphone according to claim 12, wherein the embedded body further includes two magnetic members disposed on two sides of an electrode terminal, and when the earphone is placed into a charging case, the two magnetic members are magnetically engaged with corresponding magnetic members in the charging case.

15. The earphone according to claim 1, wherein
the earphone further comprises an ear hook part, and the ear hook part has a symmetry plane arranged along a length direction of the ear hook part and has an x1 direction perpendicular to the symmetry plane,
the earphone further comprises a rigid bracket disposed in the accommodation cavity,
the rigid bracket includes a first end plate, a second end plate, a third end plate, a fourth end plate 221d, a first side plate, a second side plate, and a third side plate,
the first end plate, the second end plate, and the third end plate are sequentially spaced apart along the x1 direction, and the third end plate is located on a side of the second end plate away from the first end plate,
the first side plate connects the first end plate and the second end plate, so as to form a battery accommodation region between the first end plate and the second end plate,
the second side plate connects the second end plate and the third end plate, so as to form a first circuit board accommodation region between the second end plate and the third end plate,
the fourth end plate is located on a side of the first end plate away from the second end plate, and is spaced apart from the first end plate along the first direction, and
the third side plate connects the fourth end plate and the first end plate, so as to form a second circuit board accommodation region.

16. The earphone according to claim 15, wherein the rigid bracket is a one-piece molded part.

17. The earphone according to claim 15, wherein a plurality of rib structures are provided on side walls of the first end plate, the second end plate, the third end plate, and the fourth end plate along the x1 direction, respectively.

18. The earphone according to claim 14, wherein a projection of the first end plate and a projection of the second end plate along the axial direction of the battery overlap with the end surface of the battery.

19. The earphone according to claim 14, wherein in a reference cross-section perpendicular to the axial direction of the battery, an inner side of the first side plate is arranged in an arc shape adapted to an outer circumferential surface of the battery.

20. The earphone according to claim 14, wherein the first flexible circuit board is attached to a side of the first side plate away from the battery accommodation region.
